(19) United States
(12) Patent Application Publication
(10) Pub. No.: US 2025/0069259 A1
(43) Pub. Date: Feb. 27, 2025

(54) REAL-TIME EXTRACTION OF HUMAN POSES FROM VIDEO FOR ANIMATION OF AVATARS

(71) Applicant: Roblox Corporation, San Mateo, CA (US)

(72) Inventors: Xiaoxia SUN, Saratoga, CA (US); Alexander B. WEISS, Pleasanton, CA (US); Timothy Paul OMERNICK, San Diego, CA (US); Marcel VAN WORKUM, San Mateo, CA (US); Marcin SUSZCZEWICZ, San Mateo, CA (US); Tinghui ZHOU, Castro Valley, CA (US)

(73) Assignee: Roblox Corporation, San Mateo, CA (US)

(21) Appl. No.: 18/814,072

(22) Filed: Aug. 23, 2024

Related U.S. Application Data
(60) Provisional application No. 63/534,534, filed on Aug. 24, 2023.

(51) Int. Cl. G06T 7/73; G06T 13/40

(52) U.S. Cl. CPC G06T 7/73; G06T 13/40; G06T 2207/10016; G06T 2207/30196

(57) ABSTRACT

Real-time extraction of human poses from video data for animation of avatars. In some implementations, a computer-implemented method includes obtaining an input video including a plurality of video frames in a sequence that depict movement of a person based on a plurality of poses of the person in the input video. Keypoints of the person are detected in the video frames of the input video data, and a sequence of 3D body poses are determined that correspond to the plurality of poses of the person in the video frames of the input video. Determining the 3D body poses includes using a spatial-temporal transformer to determine joint angles of the keypoints, where the spatial-temporal transformer separately encodes inputs in spatial dimensions within each video frame and a temporal dimension across the video frames.

### CROSS-REFERENCE TO RELATED APPLICATIONS

This application claims priority under 35 U.S.C. § 119(e) to U.S. Provisional Patent Application No. 63/534,534, filed on Aug. 24, 2023, the contents of which are hereby incorporated by reference herein in its entirety.

### BACKGROUND

Animations of three-dimensional (3D) computer-generated models are used in a variety of applications including the presentation of motion of characters (avatars) and objects in computer environments such as in games, movies, etc. Manually creating high-quality animations for computer models is an expensive and time-consuming process, requiring specialized skill sets and hours of manual labor. Techniques such as motion capture (mocap) have been devised, in which a computer model of a person mimics motion of a corresponding real person that is captured using sensor devices that detect and record the person's motion. The computer model is animated to follow the motion of the physical person based on the captured motion data. However, motion capture is expensive and difficult to set up.

Advances in machine learning have led to other techniques involving motion capture and resulting animation based solely on camera images. In some techniques, the motion of a person depicted in sequential images such as a video can be determined and transferred to a computer model, such that the computer model copies the motion depicted in the video. Motion depicted in a two-dimensional video is detected and converted to three dimensions, and thus is transferrable to the computer model. However, current machine learning techniques for motion capture from images produce low-quality, inaccurate poses and animations and are computationally expensive due to requiring significant processing capabilities and other computer resource requirements. In addition, current techniques require significant computation that produces poses with delay, and thus are inadequate for applications that require real-time output of poses and animations from video.

The background description provided herein is to present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of this application relate to real-time extraction of human poses from video for animation of avatars. In some implementations, a computer-implemented method includes obtaining an input video including a plurality of video frames in a sequence, wherein the video frames include pixels that depict movement of a person based on a plurality of poses of the person in the input video; detecting, by at least one processor, keypoints of the person in the video frames of the input video; and determining, by the at least one processor, a sequence of 3D body poses that correspond to the plurality of poses of the person in the video frames of the input video, wherein determining the 3D body poses includes using a spatial-temporal transformer to determine joint angles of the keypoints, wherein the spatial-temporal transformer separately encodes inputs in spatial dimensions within each video frame and in a temporal dimension across the video frames.

Various implementations and examples of the method are described. For example, in some implementations, the spatial-temporal transformer outputs 6-dimensional (6D) circular representations of the joint angles of the keypoints of the 3D body poses, and the method further includes converting the 6D circular representations of the joint angles into 3-dimensional (3D) joint angles of the keypoints. In some implementations, determining the sequence of 3D body poses includes determining, by the at least one processor, a global translation in 3D world coordinates for the 3D body poses. In some implementations, determining the global translation in 3D world coordinates includes predicting translation velocity of the global translation. In some implementations, determining the global translation in 3D world coordinates includes using a second spatial-temporal transformer that separately encodes inputs in the spatial dimensions within each video frame and in the temporal dimension across the video frames.

In some implementations, the method further includes smoothing, by the at least one processor, jitters in the sequence of 3D body poses using a smoothing filter that includes an optimization solver. In some implementations, the optimization solver includes an alternating direction method of multipliers (ADMM) solver. In some implementations, the smoothing filter minimizes an acceleration of one or more keypoints in the sequence of 3D body poses. In some implementations, the smoothing filter minimizes an L1 recovery error for the acceleration of the one or more keypoints in the sequence of 3D body poses.

In some implementations, the method further includes applying the sequence of 3D body poses to an avatar in a virtual environment to cause an animation of the avatar based on the sequence of 3D body poses that corresponds to the movement of the person in the input video.

In some implementations, a system includes at least one processor; and a memory coupled to the at least one processor, with software instructions stored thereon that, when executed by the at least one processor, cause the at least one processor to perform operations. The operations include obtaining an input video including a plurality of video frames in a sequence, wherein the video frames include pixels that depict movement of a person based on a plurality of poses of the person in the input video; detecting keypoints of the person in the video frames of the input video; determining, using a transformer, 6-dimensional (6D) circular representations of joint angles of the keypoints, wherein the transformer processes and outputs the 6-dimensional (6D) circular representations of the joint angles of the keypoints; converting the 6D circular representations of the joint angles into 3-dimensional (3D) joint angles of the keypoints; and outputting a sequence of 3D body poses that correspond to the plurality of poses of the person in the video frames of the input video, wherein the sequence of 3D body poses includes the 3D joint angles of the keypoints for the video frames of the input video.

In some implementations of the system, the transformer is a spatial-temporal transformer that separately encodes inputs in spatial dimensions within each video frame and in a temporal dimension across the video frames. In some implementations, the operations further include determining a global translation in 3D world coordinates for the 3D body poses using a transformer that predicts translation velocity of the global translation. In some implementations, the operation of determining the global translation in 3D world coordinates includes using a second spatial-temporal transformer that separately encodes inputs in spatial dimensions within each video frame and in a temporal dimension across the video frames. In some implementations, the operations further comprise smoothing jitters in the sequence of 3D body poses using a smoothing filter that includes an optimization solver. In some implementations, the smoothing filter minimizes an acceleration of one or more keypoints in the sequence of 3D body poses. In some implementations, the optimization solver includes an alternating direction method of multipliers (ADMM) solver.

In some implementations, the operations further comprise applying the sequence of 3D body poses to an avatar in a virtual environment to cause an animation of the avatar based on the sequence of 3D body poses that corresponds to the movement of the person in the input video.

In some implementations, a non-transitory computer-readable medium with instructions stored thereon that, when executed by a processor, cause the processor to perform operations. The operations include obtaining an input video including a plurality of video frames in a sequence, wherein the video frames include pixels that depict movement of a person based on a plurality of poses of the person in the input video; detecting keypoints of the person in the video frames of the input video data; determining a plurality of joint angles for the detected keypoints that provide a sequence of 3D body poses corresponding to poses of the person in the video frames of the input video data; and determining a global translation in 3D world coordinates for the 3D body poses using a transformer that predicts translation velocity of the global translation. In some implementations, the transformer is a spatial-temporal transformer that separately encodes inputs in spatial dimensions within each video frame and in a temporal dimension across the video frames.

Some implementations provide a device that includes a processor and a memory coupled to the processor. The memory may have instructions stored thereon that, when executed by the processor, cause the processor to perform operations that include one or more of the features described for any of the methods or systems above. Some implementations provide a non-transitory computer-readable medium with instructions stored thereon that, when executed by a processor, cause the processor to perform operations that may be similar to one or more features described for any of the methods and/or systems above.

### BRIEF DESCRIPTION OF THE DRAWINGS

FIG. 1 is a diagram of an example system architecture, in accordance with some implementations.

FIG. 2 is a block diagram of an example system to determine a pose sequence of 3D poses from an input video, in accordance with some implementations.

FIG. 3 is an example system that can provide 3D human poses from video, in accordance with some implementations.

FIGS. 4A and 4B illustrate examples of 2D keypoints that can be detected for a person in a video, in accordance with some implementations.

FIG. 5 is a block diagram illustrating an example joint angle recovery block, in accordance with some implementations.

FIG. 6 is a block diagram illustrating an example global translation recovery block, in accordance with some implementations.

FIG. 7 is a block diagram illustrating an example smooth filter, in accordance with some implementations.

FIG. 8 is a flow diagram illustrating a method to determine a pose sequence of 3D poses from an input video, in accordance with some implementations.

FIG. 9 is a block diagram illustrating an example computing device which may be used to implement one or more features described herein, in accordance with some implementations.

### DETAILED DESCRIPTION

One or more implementations described herein relate to real-time extraction of human poses in a video. The human poses can be used, for example, to provide animation of computer models such as avatars. In some implementations, features can include determining a sequence of 3D poses of a person that correspond to frames of a video. The 3D poses include 3D joint angles that can be determined using a spatial-temporal transformer to encode inputs in spatial and temporal dimensions separately. In some implementations, the transformer outputs a 6D circular representation of joint angles to reduce severe unnatural jitters in the recovered human pose sequence, and the 6D joint angles are converted into 3D joint angles in the output 3D poses. In some implementations, global translation of the 3D poses can be determined by providing 3D world coordinates for the body poses. In some implementations, a spatial-temporal transformer can be trained to fit translation velocity instead of location, and can predict the velocity of the global translation to determine the 3D world coordinates for the global translation in 3D space for the body poses. In some implementations, a smoothing filter that suppresses sparse and sudden accelerations of body parts can be used to smooth jitters in the body pose sequence.

Features described herein provide accurate, robust, and computationally efficient determination of a sequence of poses of a human body model (e.g., a humanoid avatar) that correspond to movement of a person depicted in a video. The poses of the human body model can be converted to apply to a computer model, e.g., an avatar in a virtual experience that is part of a virtual environment or metaverse.

Described features provide an accurate pose sequence that closely corresponds to the motion in the video and makes efficient use of computational resources to allow for fast, real-time determination of 3D body poses from a video. For example, the use of a spatial-temporal transformer allows spatial processing to determine joint angles and world coordinates from keypoints correlated within a frame (for each frame) and allows separate temporal processing to determine joint angles and world coordinates from corresponding keypoints correlated across multiple frames of the video. The separate spatial and temporal processing allows longer sequences of pose keypoints to be processed to determine joint angles and/or global translation within memory constraints of a system, compared to processing all of the keypoints within frames and across frames of the sequence that has much larger memory requirements. Processing a longer sequence of pose keypoints allows, for example, the estimation of poses to be more stable and have reduced jitter compared to processing shorter sequences.

In addition, in some implementations, global translation of 3D body poses (e.g., determination of location of poses within a virtual 3D environment) can be determined by a spatial-temporal transformer that is trained to fit translation velocity of a body pose instead of location of the pose in the environment, such that the transformer predicts the velocity of global translation to determine the 3D world coordinates for the global translation in 3D space for the body poses. Training a transformer for prediction of velocity is more efficient and accurate than training for prediction of location, since location characteristics have many ambiguities based on different sizes of objects, distances from a camera (that captures an input video), size of environment, scarcity of training data, etc.

Furthermore, described techniques produces relatively low jitter in the body poses to allow smooth animations that more accurately follow the motion of a person in the video. In many previous techniques, pose sequences often do not correspond accurately to the video. For example, previous techniques often provide pose sequences having unnatural motion, e.g., including temporal inconsistencies or discontinuities in the form of jitters and/or other subtle motion effects that do not appear natural. In contrast, implementations of techniques described herein reduce such temporal inconsistencies in a pose sequence to provide natural motion of an avatar. For example, in some implementations a smoothing filter can be used that optimizes for suppression of sparse and sudden acceleration of body parts, which may be a result of inaccurate detection of keypoints in a body pose. Such suppression reduces the jitter in the resulting 3D body pose sequence. Furthermore, this optimization can be performed fast and within few iterations, thus being suitable for real-time extraction of body poses from streaming video.

Described features thus provide technical advantages that enable reduction of use of computational resources (e.g., computer memory, processor use and time, networking traffic bandwidth, etc.) to create accurate and realistic pose sequences from video frames that can be used to animate computer models such as avatars.

Some implementations described herein may include a computer-implemented method that includes described operations performed by a processor of a system. Some implementations may include a system that includes a processor and a memory coupled to the processor. The memory may have instructions stored thereon that, when executed by the processor, cause the processor to perform operations that include one or more of the features of the methods described herein. Some implementations may include a non-transitory computer-readable medium with instructions stored thereon that, when executed by a processor, cause the processor to perform operations that can be similar to features of the techniques and/or systems described herein.

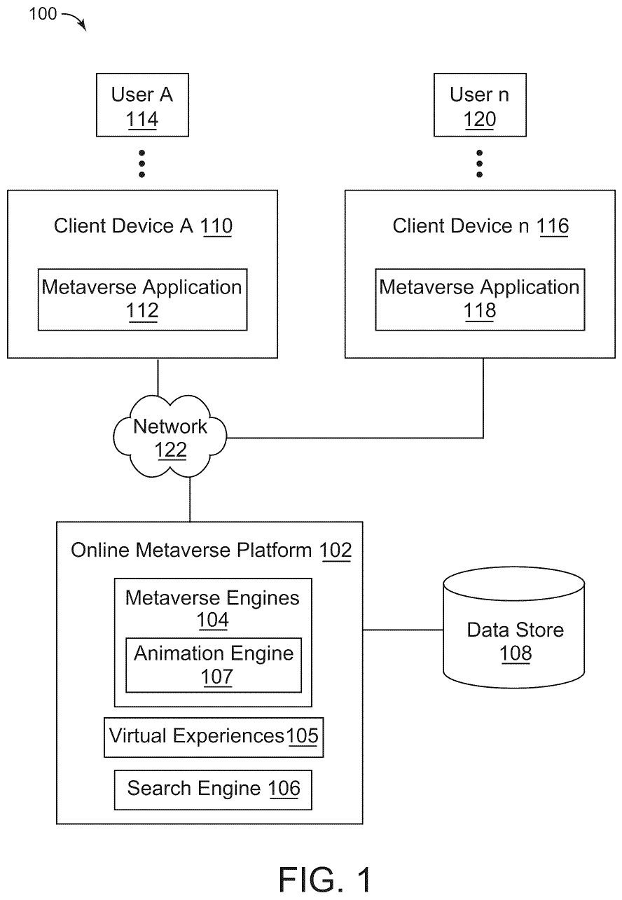

FIG. 1 illustrates an example system architecture 100, in accordance with some implementations of the disclosure. System architecture 100 is provided for illustration. In some implementations, the system architecture 100 may include the same, fewer, more, or different elements configured in the same or different manner as that shown in FIG. 1. System architecture 100 (also referred to as “system” herein) includes an online metaverse platform 102, a first client device 110 (generally referred to as “client devices 110/116” herein), a network 122, and a second client device 116. The online metaverse platform 102 can include, among other things, a metaverse engine 104, one or more virtual experiences 105, a search engine 106, an animation engine 107, and a data store 108. The client device 110 can include a metaverse application 112. The client system 116 can include a metaverse application 118. Users 114 and 120 can use client devices 110 and 116, respectively, to interact with the online metaverse platform 102.

The terms “virtual experience” or “game,” as used herein, refers to any virtual experience in a computer (virtual) environment, including games with specified objectives or end states, as well as other types of virtual experiences such as concerts, meetings, virtual gatherings, etc. that may not have a specific objective or end state. The virtual experience may include one or more avatars or character models. An avatar may be controlled by a human user, or may be a computer-animated avatar controlled by the metaverse platform and/or client device. In various implementations, an avatar may be a humanoid, an animal form, a vehicle form, or in any other form. In some implementations, the avatar may include a mesh (a set of points arranged in 3D space to obtain an avatar with body parts such as head, torso, limbs, etc.). Further, in some implementations, a texture may be attached to a mesh. The texture may define avatar skin parameters such as color, reflectivity, shape, etc. In various implementations, avatar animation may be performed automatically by metaverse engine 104 and/or by metaverse applications (112, 118). A metaverse platform, as described herein, may include any platform that provides one or more virtual experiences in a virtual environment or metaverse. A metaverse application, as described herein, may include any application that enables a user to participate in a virtual experience, including configuring an avatar, moving about in 3D space (of the virtual experience), performing actions, engaging with other avatars, interacting with other users via text/audio/video chat, etc.

Online metaverse platform 102 (also referred to as “user-generated content platform” or “user-generated content system”) can offer a variety of ways for users to interact with one another. For example, users of an online metaverse platform may play games or other virtual experiences that are provided by the platform, e.g., virtual experiences that include player-controlled characters (avatars), non-player characters (avatars), and other virtual experience objects and mechanisms. Some online metaverse platforms can provide a variety of different environments (e.g., two dimensional or virtual three-dimensional environments) in which users can play online virtual experiences. In some implementations, users of an online metaverse platform may create virtual experiences or other content or resources (e.g., avatars, graphics, items for game play within a virtual world, etc.) within the metaverse platform. Users of an online metaverse platform may work together towards a common goal in a virtual experience or in virtual experience creation, share various virtual gaming items, send electronic messages to one another, and so forth. An online metaverse platform may also allow users of the platform to communicate with each other, e.g., using voice messages (e.g., via voice chat), text messaging, video messaging, or a combination of the above.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In one implementation, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online metaverse platform 102 can include a server having one or more computing devices (e.g., a cloud computing system, a rackmount server, a server computer, cluster of physical servers, virtual server, etc.). In some implementations, a server may be included in the online metaverse platform 102, be an independent system, or be part of another system or platform.

In some implementations, the online metaverse platform 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online metaverse platform 102 and to provide a user with access to online metaverse platform 102. The online metaverse platform 102 may also include a website (e.g., one or more webpages) or application back-end software that may be used to provide a user with access to content provided by online metaverse platform 102. For example, users may access online metaverse platform 102 using the metaverse application 112/118 on client devices 110/116, respectively.

In some implementations, online metaverse platform 102 may be a type of social network providing connections between users or a type of user-generated content system that allows users (e.g., end-users or consumers) to communicate with other users via the online metaverse platform 102, where the communication may include voice chat, video chat, or text chat. In some implementations of the disclosure, a “user” may be represented as a single individual person. However, other implementations of the disclosure encompass a “user” (e.g., creating user) being an entity controlled by a set of users or an automated source. For example, a set of individual users federated as a community or group in a user-generated content system may be considered a “user.” In some implementations, a “user” can include one or more programs or virtual entities, as well as persons that interface with the system or network.

In some implementations, online metaverse platform 102 may be a virtual gaming platform. For example, the gaming platform may provide single-player or multiplayer games and other virtual experiences to a community of users that may access or interact with virtual experiences (e.g., user generated virtual experiences or other virtual experiences) using client devices 110/116 via network 122. In some implementations, virtual experiences may be two-dimensional (2D) virtual experiences, three-dimensional (3D) virtual experiences (e.g., 3D user-generated virtual experiences), virtual reality (VR) virtual experiences or environments, or augmented reality (AR) virtual experiences, for example. In some implementations, virtual experiences can include environments which may not have game goals, e.g., simulators of particular actions or environments which a player can explore and/or interact with. In some implementations, users may search for virtual experiences and participate in virtual experiences with other users in one or more virtual experiences selected from results of the search. In some implementations, a virtual experience selected from results of the search may be played in real-time with other users of the virtual experience.

In some implementations, other platforms can be used with the pose sequence determination and/or animation features described herein instead of or in addition to online metaverse platform 102. For example, a social networking platform, purchasing platform, messaging platform, creation platform, etc. can be used to match users to other users and/or platform features, functions, and services.

In some implementations, gameplay or play may refer to interaction of one or more players using client devices (e.g., 110 and/or 116) within a virtual experience (e.g., 105) or the presentation of the interaction on a display or other output device of a client device 110 or 116.

One or more virtual experiences 105 are provided by the online metaverse platform. In some implementations, a virtual experience 105 can include an electronic file that can be executed or loaded using software, firmware or hardware configured to present the virtual experience content (e.g., digital media item) to an entity. In some implementations, a metaverse application 112/118 of a virtual experience may be executed and one or more virtual experience instances can be rendered in connection with a virtual experience 105 and metaverse engine 104. In some implementations, a virtual experience 105 may have a common set of rules and/or common goal, and the environments of a virtual experience share the common set of rules and/or common goal. In some implementations, different virtual experiences 105 may have different rules or goals from one another.

In some implementations, virtual experiences 105 may have one or more environments (also referred to as “gaming environments” or “virtual environments” herein) where multiple environments may be linked. An example of an environment may be a three-dimensional (3D) environment. The one or more environments of a virtual experience may be collectively referred to a “world” or “gaming world” or “virtual world” or “universe” herein. An example of a world may be a 3D world of a virtual experience. For example, a user may build a virtual environment that is linked to another virtual environment created by another user. An avatar in the virtual experience may cross the virtual border of one virtual environment to enter an adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online metaverse platform 102 can host one or more virtual experiences 105 and can permit users to interact with the virtual experiences 105 (e.g., create, modify, search for, request, and/or join a virtual experience 105, virtual experience instances of virtual experience 105, virtual experience-related content, or other content) using a metaverse application 112/118 of client devices 110/116. Users (e.g., 114 and/or 120) of the online metaverse platform 102 may play, create, interact with, or build virtual experiences 105, search for virtual experiences 105, communicate with other users, create and build objects (e.g., also referred to as “item(s)” or “virtual experience objects” or “virtual item(s)” herein) of virtual experiences 105, and/or select or search for objects. For example, when generating user-generated virtual items, users may create avatars, attributes or actions for the created avatars, decoration for the avatars, one or more virtual environments for an interactive virtual experience, or build structures used in a virtual experience, among others. In some implementations, users may buy, sell, or trade virtual experience objects, such as in-platform currency (e.g., virtual currency), with other users of the online metaverse platform 102. In some implementations, online metaverse platform 102 may transmit virtual experience content to metaverse applications (e.g., 112). In some implementations, virtual experience content (also referred to as “content” herein) may refer to any data or software instructions (e.g., virtual experience objects, virtual experience, user information, video, images, commands, media item, etc.) associated with online metaverse platform 102 or metaverse applications. In some implementations, virtual experience objects (e.g., also referred to as “item(s)” or “objects” or “virtual item(s)” herein) may refer to objects that are used, created, shared or otherwise depicted in virtual experiences 105 of the online metaverse platform 102 or metaverse applications 112 or 118 of the client devices 110/116. For example, virtual objects may include a part, model, avatar, tools, weapons, clothing, buildings, vehicles, currency, flora, fauna, components of the aforementioned (e.g., windows of a building), and so forth.

In some implementations, a user can create or modify a computer model that is a virtual object, such as an avatar (e.g., character model) used in one or more virtual experiences. For example, the user can create or modify a skeleton, shape, surface texture and color, and/or other attributes of an avatar. In some examples, an avatar can be similar to a human body model, e.g., can have a head, torso/abdomen, arms, legs, hands, feet, joints, etc. and can move similarly to a human body (e.g., walk, run, jump, turn head, move arms, etc.). In some cases, the avatar can have fewer joints than a human body, and in other cases, the avatar can have all joints or more joints than a human body.

In some implementations, an avatar can be animated by a user, e.g., instructed to move within a computer generated environment. For example, instructions can be provided to move one or more parts of the avatar (e.g., parts corresponding to limbs or body parts of a human) to one or more different poses, each pose providing particular joint angles for joints of the avatar. The instructions to move the model can be provided from a user in an editor interface, e.g., the user commanding the movement via input in the interface. In some cases, the instructions can be provided from storage and can include a sequence of poses for the avatar, where each pose indicates joint angles for the joints of the avatar (and/or a global translation of 3D environment/world coordinates for the avatar), and where the avatar is moved to each pose in the pose sequence. In some examples, each pose of the avatar can be captured as an animation frame of an animation that is stored as a sequence of poses of the avatar. If the animation is commanded to play (e.g., in response to the user providing particular input in an interface or during a virtual experience, or a virtual experience causing the animation to play due to an event in a virtual experience or other environment), the avatar is moved to each pose of the animation in the pose sequence, according to a specified play rate and any other play parameters.

It may be noted that the online metaverse platform 102 is provided for purposes of illustration, rather than limitation.

In some implementations, a virtual experience 105 may be associated with a particular user or a particular group of users (e.g., a private virtual experience), or made widely available to users of the online metaverse platform 102 (e.g., a public virtual experience). In some implementations, where online metaverse platform 102 associates one or more virtual experiences 105 with a specific user or group of users, online metaverse platform 102 may associate the specific user(s) with a virtual experience 105 using user account information (e.g., a user account identifier such as username and password).

In some implementations, online metaverse platform 102 or client devices 110/116 may include metaverse engines 104 or metaverse application 112/118. In some implementations, the metaverse engines 104 can include a metaverse application similar to metaverse application 112/118. In some implementations, metaverse engines 104 may be used for the development and/or execution of virtual experiences 105. For example, metaverse engines 104 may include a rendering engine (“renderer”) for 2D, 3D, VR, or AR graphics, a physics engine, a collision detection engine (and collision response), sound engine, scripting functionality, artificial intelligence engine, networking functionality, streaming functionality, memory management functionality, threading functionality, scene graph functionality, or video support for cinematics, among other features.

Metaverse engines 104 may also include an animation engine 107, including features that can convert person movement in videos to animations for avatars, as described herein. In some examples, a user of a client device 110/116 can upload a video via network 122 to the online metaverse platform 102, or a video can be streamed to platform 102 by the user or a system. A video-to-animation service of the online metaverse platform 102 can provide the video to animation engine 107, which can include machine learning model(s) and other components that perform pose sequence extraction and generation from the input video as described herein. In some implementations, these machine learning models can be implemented on a GPU of a device providing the online metaverse platform. A generated pose sequence can be provided by the animation engine 107 to the service as an animation (e.g., animation specification). The service can return the animation to the client device 110/116. In some implementations, the editor application can modify the pose sequence to correspond to a particular avatar that the user has selected, e.g., reduce the number of joints, adjust the lengths of links of the skeleton between joints, etc. If the user commands (e.g., in an editor interface displayed by the client device) the animation specification to be played on a selected avatar, animation of the avatar corresponding to the animation specification is displayed by the client device.

The components of the metaverse engines 104 may generate commands that help compute and render a virtual experience instance of the virtual experience 105 (e.g., rendering commands, collision commands, physics commands, etc.). In some implementations, metaverse applications 112/118 of client devices 110/116, respectively, may work independently, in collaboration with metaverse engine 104 of online metaverse platform 102, or a combination of both.

In some implementations, both the online metaverse platform 102 and client devices 110/116 execute a metaverse engine (104, 112, and 118, respectively). The online metaverse platform 102 using metaverse engine 104 may perform some or all the metaverse engine functions (e.g., generate physics commands, rendering commands, etc.), or offload some or all the metaverse engine functions to metaverse applications 112 and 118 of client devices 110 and 116, respectively. In some implementations, each virtual experience 105 may have a different ratio between the metaverse engine functions that are performed on the online metaverse platform 102 and the metaverse engine functions that are performed on the client devices 110 and 116. For example, a metaverse engine 104 of the online metaverse platform 102 may be used to generate physics commands in cases where there is a collision between at least two virtual objects, while the additional metaverse engine functionality (e.g., generate rendering commands) may be offloaded to the client device 110. In some implementations, the ratio of metaverse engine functions performed on the online metaverse platform 102 and client device 110 may be changed (e.g., dynamically) based on virtual experience play conditions. For example, if the number of users participating in a virtual experience 105 exceeds a threshold number, the online metaverse platform 102 may perform one or more metaverse engine functions that were previously performed by the client devices 110 or 116.

For example, players may be playing in an instance of a virtual experience 105 on client devices 110 and 116, and may send control instructions (e.g., user inputs, such as directional inputs of right, left, up, down, avatar position and velocity information, text, voice input, etc.) to the online metaverse platform 102. Subsequent to receiving control instructions from the client devices 110 and 116, the online metaverse platform 102 may send play instructions (e.g., position and velocity information of the avatars participating in the group experience or commands, such as rendering commands, collision commands, etc.) to the client devices 110 and 116 based on control instructions. For instance, the online metaverse platform 102 may perform one or more logical operations (e.g., using metaverse engine 104) on the control instructions to generate play instruction for the client devices 110 and 116. In other instances, online metaverse platform 102 may pass one or more or the control instructions from one client device 110 to other client devices (e.g., 116) participating in the virtual experience instance. The client devices 110 and 116 may use the play instructions and render the play for presentation on the displays of client devices 110 and 116.

In some implementations, the control instructions may refer to instructions that are indicative of actions of a user-controlled avatar in the virtual environment. For example, control instructions may include user input to control the action, such as right, left, up, down, user selection, gyroscope position and orientation data, force sensor data, text, voice input, etc. The control instructions may include avatar position and velocity information. In some implementations, the control instructions are sent directly to the online metaverse platform 102. In other implementations, the control instructions may be sent from a client device 110 to another client device (e.g., 116), where the other client device generates play instructions using the local metaverse application 118. The control instructions may include instructions to play a voice communication message or other sounds from another user on an audio device (e.g., speakers, headphones, etc.).

In some implementations, play instructions may refer to instructions that allow a client device 110 (or 116) to render play of a virtual experience in a virtual experience instance, such as a multiplayer game. The play instructions may include one or more of user input (e.g., control instructions), avatar position and velocity information, or commands (e.g., physics commands, rendering commands, collision commands, etc.).

In some implementations, the play instructions can cause an animation associated with a virtual object, such as an avatar, to be played in a virtual environment of the virtual experience. For example, control instructions can include a direct command to play an animation that causes the avatar to move (e.g., walk, jump, swing arms, dance, etc.). In some examples, control instructions that move an avatar may cause an animation of the avatar to commence based on interactions of the avatar with the virtual environment. For example, the avatar being moved off a ledge can cause a falling animation to be played for the avatar.

In some implementations, virtual objects (e.g., avatars, characters) are constructed from components, one or more of which may be selected by the user, that automatically join together to aid the user in editing. One or more avatars (also referred to as a “computer model,” “character,” or “character model” herein) may be associated with a player where the player may control the avatar when playing a virtual experience 105 to facilitate the player's interaction with the virtual experience 105. In some implementations, an avatar may include components such as body parts (e.g., hair, arms, legs, etc.) and accessories (e.g., t-shirt, glasses, decorative images, tools, etc.). In some implementations, body parts of avatars that are customizable by a player include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools. In some implementations, a player may control the scale (e.g., height, width, or depth) of an avatar or the scale of components of an avatar. In some implementations, the player may control the proportions of an avatar (e.g., blocky, anatomical, etc.). In some implementations, an avatar may not include an avatar object (e.g., body parts, etc.) but the player may control the avatar (without the avatar object) to facilitate the player's interaction with the virtual experience (e.g., a puzzle game where there is no rendered avatar object, but a player user controls an avatar (e.g., invisible in the virtual environment) to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creation and editing module and interface of metaverse application 112/118 (or metaverse engines 104) may publish a user's avatar for view or use by other users of the online metaverse platform 102. In some implementations, creating, modifying, or customizing avatars, other virtual objects, virtual experiences 105, or virtual environments may be performed by a user using a user interface (e.g., developer interface) and with or without scripting (or with or without an application programming interface (API)). For example, a developer interface can be displayed by a client device 110 and the user at the client device can select user interface commands to create and/or modify virtual objects (including avatars), environments, and scripts for a virtual experience. It may be noted that for purposes of illustration, rather than limitation, avatars are described as having a humanoid form. It may further be noted that avatars may have any form such as a vehicle, animal, inanimate object, or other creative form.

In some implementations, the online metaverse platform 102 may store avatars (e.g., characters) created by users in the data store 108. In some implementations, the online metaverse platform 102 maintains an avatar catalog and virtual experience catalog that may be presented to users via a user interface. In some implementations, the virtual experience catalog includes images of virtual experiences stored on the online metaverse platform 102. In addition, a user may select an avatar (e.g., an avatar created by the user or other user) from the avatar catalog to participate in the chosen virtual experience. The avatar catalog includes images of avatars stored on the online metaverse platform 102. In some implementations, one or more of the avatars in the avatar catalog may have been created or customized by the user, and/or created or customized by other users. In some implementations, the chosen avatar may have avatar settings defining one or more of the components of the avatar. In some implementations, some avatars or portions of avatars (and/or data associated with the avatars) can be stored locally to client devices 110/116.

In some implementations, a user's avatar can include a configuration of components, where the configuration and appearance of components and more generally the appearance of the avatar may be defined by avatar settings. In some implementations, the avatar settings of a user's avatar may at least in part be chosen by the user. In other implementations, a user may choose an avatar with default avatar settings or avatar setting chosen by other users. For example, a user may choose a default avatar from an avatar catalog that has predefined avatar settings, and the user may further customize the default avatar by changing some of the avatar settings (e.g., adding a shirt with a customized logo). The avatar settings may be associated with a particular avatar by the online metaverse platform 102.

Avatar settings can also include one or more animations associated with an avatar. An animation, when played, causes the avatar to move within the environment and/or move particular body parts or other physical features of the avatar. Each animation can include a sequence of multiple poses which the avatar assumes in a virtual environment to cause the avatar to move or be otherwise changed in physical (displayed) appearance. For example, some animations can cause the avatar to have a particular facial expression (e.g., smile, frown, yell, laugh, etc.). Some animations can cause the one or more of the avatar's body components to move in a particular manner, e.g., to cause the avatar to walk, run, dive to the ground, jump, stagger, hop, roll on the ground, somersault, perform exercises, nod the head, shake the head from side to side, shrug shoulders, etc. An avatar can be associated with multiple animations, and each animation can be designated by a user (e.g., using the developer interface of metaverse application 112/118 or metaverse engines 104) to trigger and be played based on respective particular condition(s). For example, an animation can be designated by a user to be played on an avatar when the avatar is first displayed in a virtual environment or at other selected times after appearing within the virtual environment. Some animations can be designated to play for the avatar in response to a user command during the virtual experience, such as an action to move the avatar in the virtual environment, act on a different object in the virtual environment, a specific command to play the particular animation, etc.

According to features described herein, an animation (including a sequence of poses) can be created from a video. In some implementations, the video is input by the user to the online metaverse platform, e.g., uploaded to the metaverse platform from a client device. The animation engine 107, using one or more features described herein, can process the input video to determine a pose sequence that corresponds to movement of a person in the video, and provide an animation for an avatar based on the determined pose sequence. In some examples, the animation engine can provide the animation to a display device of a user, e.g., from a streaming video. In some examples, the animation engine 107 can provide the animation to the user as an option to be played for a specified avatar in virtual experiences in which the user created or participates. For example, the created animation can be made available to the user as an option in an editing interface (or the user's account on the gaming platform). In some implementations, the user can select the animation to be applied to an avatar and can specify the animation to trigger in response to particular conditions in a virtual environment. In some implementations, the input video can be received from any of other sources, e.g., from storage, from a device connected via the communication network, etc.

In some implementations, online metaverse platform 102 may include a search engine 106. In some implementations, the search engine 106 may be a system, application, or module that permits the online metaverse platform 102 to provide search functionality to users, where the search functionality permits the users to search virtual experiences 105 that are available, the most popular virtual experiences, virtual experience instances that are looking for players, virtual experience assets available on the gaming platform 102, etc.

In some implementations, the client device(s) 110 or 116 may each include computing devices such as personal computers (PCs), mobile devices (e.g., laptops, mobile phones, smart phones, tablet computers, or netbook computers), network-connected televisions, gaming consoles, etc. In some implementations, a client device 110 or 116 may also be referred to as a “user device.” In some implementations, one or more client devices 110 or 116 may connect to the online metaverse platform 102 at any given moment. It may be noted that the number of client devices 110 or 116 is provided as illustration, rather than limitation. In some implementations, any number of client devices 110 or 116 may be used.

In some implementations, each client device 110 or 116 may include an instance of the metaverse application 112 or 118, respectively. In one implementation, the metaverse application 112 or 118 may permit users to use and interact with online metaverse platform 102, such as search for a virtual experience or other content, control a virtual avatar in a virtual experience hosted by online metaverse platform 102, or view or create or upload content, such as virtual experiences 105, images, avatars, and other virtual objects, model animations, videos, web pages, documents, and so forth. In one example, the metaverse application may be a web application (e.g., an application that operates in conjunction with a web browser) that can access, retrieve, present, or navigate content (e.g., avatar in a virtual environment, etc.) served by a web server. In another example, the metaverse application may be a native application (e.g., a mobile application, app, or a gaming program) that is installed and executes local to client device 110 or 116 and allows users to interact with online metaverse platform 102. The metaverse application may render, display, or present the content (e.g., a web page, a media viewer) to a user. In an implementation, the metaverse application may also include an embedded media player (e.g., a Flash® player) that is embedded in a web page.

According to aspects of the disclosure, the metaverse application 112/118 may be an online metaverse platform application for users to build, create, edit, upload content to the online metaverse platform 102 as well as interact with online metaverse platform 102 (e.g., play virtual experiences 105 hosted by online metaverse platform 102). As such, the metaverse application 112/118 may be provided to the client device 110 or 116 by the online metaverse platform 102. In another example, the metaverse application 112/118 may be an application that is downloaded from a server.

In some implementations, a user may login to online metaverse platform 102 via the metaverse application. The user may access a user account by providing user account information (e.g., username and password) where the user account is associated with one or more avatars available to participate in one or more virtual experiences 105 of online metaverse platform 102.

In general, functions described in one implementation as being performed by the online metaverse platform 102 can also be performed by the client device(s) 110 or 116, or a server, in other implementations if appropriate. In addition, the functionality attributed to a particular component can be performed by different or multiple components operating together. The online metaverse platform 102 can also be accessed as a service provided to other systems or devices through appropriate application programming interfaces (APIs), and thus is not limited to use in websites.

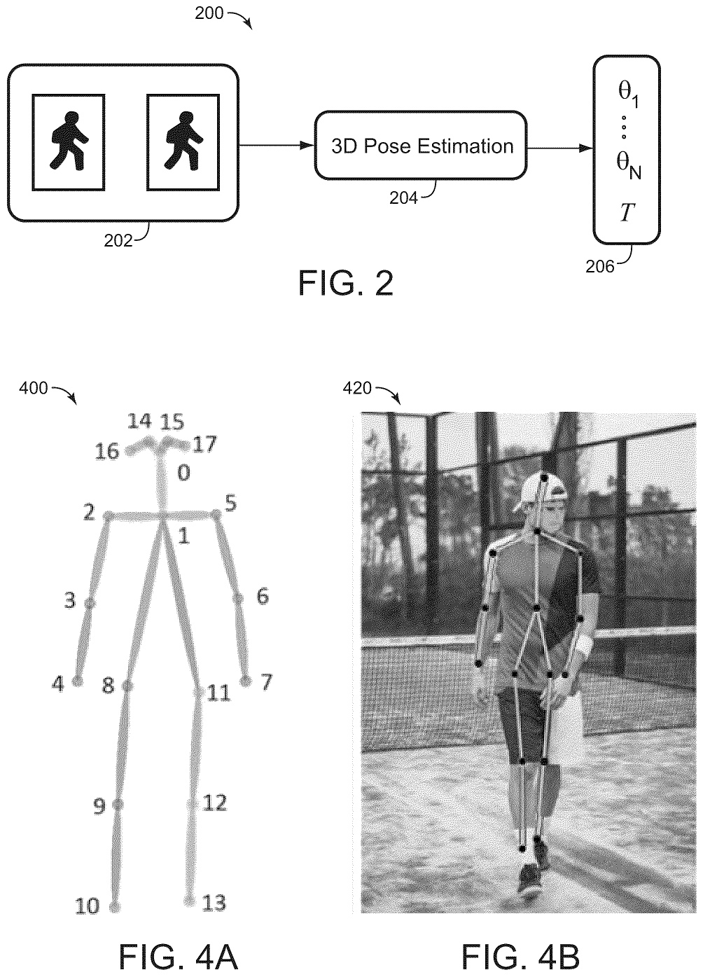

FIG. 2 is a block diagram illustrating an example system 200 to determine a pose sequence of 3D poses from an input video, in accordance with some implementations. The pose sequence can be used to provide an animation for an avatar, in accordance with some implementations. In some implementations, system 200 can be implemented, for example, in a server system, e.g., online metaverse platform 102 as shown in FIG. 1. In some implementations, system 200 can be implemented by an animation engine 107 of an online metaverse platform 102. In some implementations, some or all of the system 200 can be implemented on a system such as one or more client devices 110 and 116 as shown in FIG. 1, and/or on both a server system and one or more client systems. In described examples, the implementing system includes one or more processors or processing circuitry, and one or more storage devices such as a database, data structure, or other accessible storage. In some implementations, different components of one or more servers and/or clients can implement different parts of the system 200.

An input video in the form of video data is input to the system 200 that includes a sequence of video frames 202 (e.g., RGB video frames) that have pixels that depict a single person. In some implementations, as described below, if multiple persons are depicted in the input video, a single person is selected in the frames and the other persons are ignored.

In various implementations, the input video sequence 202 can be received at an online metaverse platform 102 as an uploaded video file from a client device of a user (e.g., client device 110/116), the video file can be received as a streaming video, or can otherwise received or obtained, e.g., from storage, via a link to an online storage location, etc. In some implementations, the video file is loaded to a processor module (e.g., animation engine 107 of FIG. 1) that processes the video into a pose sequence, e.g., for an avatar model (e.g., character model). The user can also command the system to create an animation from the input video for a specified avatar model. In some implementations, the animation can be specified by the user as a generic animation provided from the video, where the animation is not yet associated with any avatar model and can be applied to an avatar model later specified by the user.

In some implementations, the input video can be in a standard video format. The input video includes multiple frames, each frame being an image having image data defined by pixels. In some examples, the video frames depict a person moving, e.g., the person moving around in an environment depicted by the video frames and/or having one or more body parts that move (e.g., legs, arms, head, etc.).

3D pose estimation system 204 can detect and extract the poses of the person in the video. Example techniques for performing this detection and extraction are described below.

The 3D pose estimation block 204 outputs parameters 206 that describe 3D human poses. The parameters include person joint angles (theta) and a global translation (T) in 3D world coordinates for each body pose. In some implementations, parameters 206 can be used to animate an avatar (e.g., a skeleton model or rig). For example, each set of joint angles can be used to rotate the portions of the avatar by those joint angles, and the global translation parameter can be used to move the avatar in a 3D environment with respect to a reference location within the 3D environment. In some example implementations, each generated human body pose can include 21 joint angles (at particular body joint locations) and 1 global translation in 3D space, or can include different numbers and body joint locations of joint angles (e.g., 18 joint locations, etc.) in other implementations.

3D pose estimation system 204 determines a 3D human body pose in each frame of the video in real time, e.g., at real-time speed or frame rate. For example, such a real-time frame rate can be 30 frames per second (fps) or greater, in which the system 204 outputs parameters 206 at 30 fps based on input video sequence 202 having a frame rate of 30 fps or more. This allows, for example, body pose determination and/or avatar animation based on the poses to be performed that are output based on streaming input video data.

In some implementations, parameters 206 can be used to provide animation of an avatar. For example, if input video 202 is a video stream, parameters 206 can be determined in real time application as video frames of video 202 are received, and the parameters 206 can be used to animate an avatar real time coordination with the streaming input video. For example, in a live video feed (e.g., a videoconference or other feed), an avatar can be animated in a display in coordination with captured video frames that are received by system 200 via the feed. The avatar can be animated to move its body parts in coordination with the movements of the body parts of the person depicted in the video feed, e.g., to dance, walk, run, etc.

In some implementations, a user may use an editor interface that allows the user to create and modify an avatar (e.g., computer model or character model), where the user can generate and modify the avatar using edit tools provided in the interface. The pose sequence obtained in parameter block 206 can be converted to an animation for an avatar. The animation of the avatar corresponds to the movement of the person depicted in the input video. In some examples, if a user has associated the animation with an avatar, the pose sequence is applied to that avatar to provide the animation of the avatar, e.g., the positions of the joints and body parts in the pose sequence are adjusted to align with corresponding joints and body parts of the avatar. In some implementations, a pose sequence described by parameters 206 can be stored and applied to any avatar. For example, in some implementations, a user can provide an input video and apply the resulting pose sequence to one or more of their avatars, and/or make the pose sequence available to other users.

In some implementations, the user can provide a command an editor or other application program to play the animation using the avatar, which causes the avatar to be displayed on the display device to move its joints and/or its position in a computer environment to assume each of the poses in the sequence of the pose sequence. The animation can be played at a rate that is the same as or similar to the rate of playback of the input video (e.g., displayed in poses per second equal to the frames per second of the input video). In some implementations, the user can use the interface to edit the animation in various ways, e.g., adjust the rate of playback of portions of the animation or the entire animation, remove portions of the animation, add additional poses to the animation, etc. In some examples, the user can edit the animation after it has been associated with the selected avatar, or can edit the pose sequence that is not associated with any avatar.

The avatar can be added to a virtual experience or other computer generated virtual environment. Using the editor interface, the user can associate the animation, or portions thereof, with one or more particular conditions that will cause the animation to initiate and be played in the virtual environment. For example, the user can associate the animation to trigger with the initialization of the avatar in the virtual experience (e.g., the starting of the virtual experience), a particular command received by a player of the virtual experience, a particular action performed by the avatar in the virtual experience (e.g., running, jumping, attacking, etc.), an event that affects the avatar in the virtual experience (e.g., being hit by an object, falling over an edge, etc.), or other conditions. When the virtual experience is played using the avatar, the animation is played in response to the condition being detected in the virtual experience.

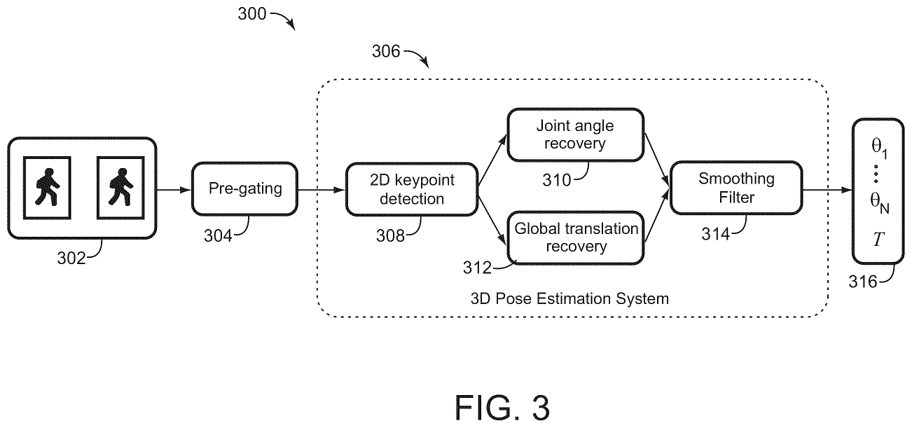

FIG. 3 is a block diagram of an example system 300 that can provide 3D human poses from input video, in accordance with some implementations.

Input video 302 is input to the system, which can be the sequence of video frames 202 of FIG. 2. In some implementations, it is determined whether input video 302 satisfies specific requirements so that it may be processed by system 300. For example, a pre-gating block 304 can determine whether the input video 302 meets the specific requirements to be processed to determine 3D poses, and/or can process data in input video 302 so that the specific requirements are met. For example, system 300 can process videos that meet certain requirements that include: a single person appears in the video (e.g., a single person is depicted in the pixels of the video), and the video depicts a human. In some implementations, if there are multiple persons depicted in the video 302, the person having the largest bounding box area (e.g., in the most frames of the video) is selected and processed. Alternate or additional requirements and processing can be used in some implementations. For example, in some implementations, the input video may have other requirements, e.g., have a duration equal to or less than a maximum duration so that processing time and resource expenditure are reduced by the system performing techniques described herein.

If these requirements are met, then a pre-gating block 304 sends the input video 302 (and/or sends processed data based on the input video, e.g., indications of the selected person selected from multiple people in the video) to the 3D pose estimation system 306. In some implementations, if the requirements are not met and video data cannot be processed so that the requirements are met, the pre-gating block 304 does not send the video to be processed by system 306.

In some implementations, 3D pose estimation system 306 can be the 3D pose estimation system 204 of FIG. 2. Pose estimation system 306 determines 3D poses from an input video. System 306 can include a 2D keypoint detection block 308, a joint angle recovery block 310, a global translation recovery block 312, and a smoothing filter 314.

2D keypoint detection block 308 receives the sequence of video frames gated by the pre-gating block 304, and outputs a sequence of 2D keypoints (also referred to as landmarks). The keypoints can include joints and/or particular points or locations of body parts. In some implementations, for the person depicted in each frame, there are N number of 2D keypoints, each keypoint represented by 2D coordinates and a confidence level. In some implementations, 2D keypoints of the person shown in the input video can be determined using a machine learning model. In some implementations, the machine learning model can be a regression model. In some implementations, the machine learning model can include a convolutional neural network (CNN) that can be used to predict where 2D joints are located on a person depicted in an image, e.g., in each frame of the input video. In some examples, a pre-trained neural network can be used to detect 2D human pose keypoints, such as joints and body parts, in the video frames and provide 2D coordinates for the locations of the joints within each frame. Other machine learning models or other techniques of keypoint detection can also be used.

In some implementations, the machine learning model (such as a CNN) receives the frames of the input video. For each frame, based on its training, the machine learning model detects a human body and keypoints of the body, e.g., the joints where an underlying skeleton of the body connect to each other and allow rotation of body parts. For example, such joints can include the top of the neck (for rotation of head), base of the neck (for rotation of the neck relative to torso), waist (for rotation of two torso portions), shoulder (for rotation of upper arm relative to torso), elbow (for rotation of forearm relative to upper arm), knuckles (for rotation of fingers relative to hand), joint at upper leg (for rotation relative to torso), knee (for rotation of lower leg relative to upper leg), ankle (for rotation of foot relative to lower leg), etc. Keypoints can also or alternatively represent body parts, such as facial features (eyes, nose, mouth, ears, etc.), a center or other location of a palm or hand, foot, arm portion (e.g., forearm, upper arm, etc.), leg segment, etc.

FIGS. 4A and 4B illustrate examples of 2D keypoints that can be detected for a person in a video. The keypoints can collectively define a human body model having a pose. In FIG. 4A, human body model 400 includes a set of numbered points, where each numbered point (total 17 points) indicates a keypoint. Keypoints can be located at skeletal joints of a person (e.g., elbows, shoulders, ankles, wrists, etc.) and/or at facial features of the person (e.g., eyes, nose, ears, etc.). In some implementations, a smoothing filter can be applied to the video to reduce jittering of 2D keypoints. Examples of smoothing filters that can be used include a One-euro filter, Kalman filter, etc. FIG. 4B shows an example video frame 420 in which some example keypoints (in black) have been detected on a person depicted in pixels of the video frame.

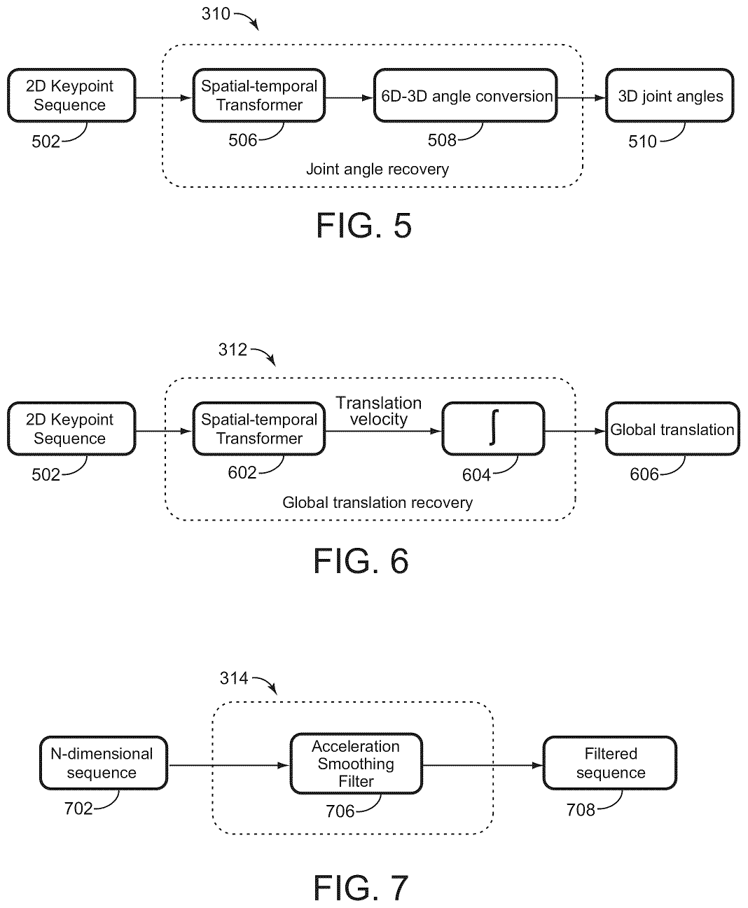

Referring back to FIG. 3, joint angle recovery block 310 receives keypoints from the 2D keypoint detection block 308. Joint angle recovery block 310 determines sequences of 3D joint angles of the person depicted in the video frames based on the received keypoints. Some examples of joint angle recovery block 310 are described below with reference to FIG. 5.

Global translation recovery block 312 receives keypoints from the 2D keypoint detection block 308. Global translation recovery block 312 determines sequences of global translation coordinates for the joints and other keypoints extracted from the video frames based on the received keypoints. Some examples of global translation recovery block 310 are described below with reference to FIG. 6.

Smoothing filter 314 receives the sequences of recovered 3D joint angles from joint angle recovery block 310 and the sequences of recovered global translation from global translation recovery block 312. Smoothing filter 314 filters the sequences of blocks 310 and 312 to provide a smoothed output sequence of body poses. Some examples of smoothing filter 314 are described below with reference to FIG. 7.

Filtered body pose sequences are output from filter 314. In some implementations, the filtered sequences can be parameters 316 that are the output of the 3D pose estimation system 306 of FIG. 3. The parameters 316 indicate body poses via joint angles and global translation for each body pose, where each body pose corresponds to a frame of the input video.

FIG. 5 is a block diagram illustrating an example of a joint angle recovery block, e.g., joint angle recovery block 310 of system 300 of FIG. 3. As shown in FIG. 5, joint angle recovery block 310 receives, as input, a 2D keypoint sequence 502 derived from multiple frames of an input video, as provided by the 2D keypoint detection block 308 of FIG. 3. The 2D keypoint sequence can include keypoints that represent 2D positions in the video frame, e.g., x-y locations.

In some implementations, 2D keypoint sequence 502 is fed into a spatial-temporal transformer 506 of block 310 that can include a machine learning model, such as a deep neural network machine learning model. Transformer 506 finds correlations and relationships between the input 2D keypoint positions to determine joint angles for the keypoints.

In some implementations, transformer 506 repeatedly encodes inputs in spatial dimensions (within frame) and a temporal dimension (across frames) separately. In some implementations, this separate encoding allows the transformer 506 to predict a larger number of joint angles over a larger number of frames without exceeding memory resources. For example, if there are 21 joints in each pose and there are 30 frames of poses in a pose sequence to be processed and predicted, that is 21×30, e.g., 630 separate predictions of joint angles. This is a sufficiently long sequence to exceed memory requirements on many systems. Therefore, for each prediction, either the spatial dimension(s) or the temporal dimension is processed by transformer 506, enabling the input sequence length to be either the number of joints or the number of frames. This allows a longer input sequence length to be processed compared to not separating the processing, which can reduce errors in the output such as jitter.

In some example implementations, transformer 506 can be a 12-layer transformer and can be composed of six blocks. Other amounts of layers and blocks can be used in other implementations. For example, every block can include two transformers, where a temporal transformer computes a temporal dimension, and then a spatial transformer computes a spatial dimension. For example, for a pose sequence of 21 joints in 30 frames, the input to the temporal transformer is the corresponding keypoint in each frame of the sequence of 30 frames (e.g., corresponding joint such as wrist, or shoulder, etc.), and a batch dimension of 21 specifies the 21 joints of each frame. The temporal transformer determines the correlation between each corresponding joint over the 30 frames separately, without looking for correlations between the 21 joints within a frame, and correlations from the individual 30 frames are summed into a combined result. For example, the combining can be performed by repeatedly inferencing through the spatial and temporal transformers of the blocks of transformer 506. Since the temporal transformer performs a matrix multiplication with only the temporal dimension that does not include the spatial dimension, the memory usage is defined by just the temporal dimension (30 in this example).

In some implementations, the encoding resulting from the temporal transformer is fed to the spatial transformer, where the input can be configured to be the reverse of the above, e.g., a sequence of 21 joints (in one pose) and a batch dimension specified for the 30 frames. The spatial transformer determines the correlation between each set of 21 joints separately, without looking for correlations between joints of different frames, and the correlations from the individual sets of 21 joints are summed into a combined result by repeatedly inferencing through the spatial and temporal transformers of the blocks of transformer 506. Since the spatial transformer performs a matrix multiplication with only the spatial dimension that does not include the temporal dimension, the memory usage is defined by just a 21 sequence length. In some implementations, the order of transformers can instead be a spatial transformer and then a temporal transformer, which provides overall the same result as the above-described temporal then spatial transformer order since the spatial and temporal transformers are repeatedly run through N times.

The input sequence length to the transformer 506 is a maximum of the number of joints or the number of frames (e.g., 30 here) and that defines the memory complexity for transformer 506. Thus, in such implementations, memory complexity never obtains a complexity higher than 30 and the transformer does not have to process a sequence length of 21 times 30. Each block of transformer 506 can similarly include a temporal transformer and a spatial transformer.

Other types of transformers or machine learning models can be used in other implementations.

In some implementations, the transformer model 506 outputs a 6D circular representation of joint angles to avoid having severe unnatural jittering of the recovered human pose. For example, using the standard 3D angles (roll, pitch, yaw) may cause jittering due to angle notation resetting back to zero after 360 degrees. In some implementations, the transformer model 506 can be trained on and can output 6D angles, e.g., angles specified with six circular dimensions that are the results of sine and cosine functions for each of the three angles in 3D (roll, pitch, yaw).

Thus, 6D-angles output by transformer model 506 can be input to angle conversion block 508 that converts (e.g., transforms) the 6D-angles into 3D-angles that are used by other portions of the system. The final output of block 310 is J number of 3D joint angles 510.

The output of joint angle recovery block 310 is J joint angles 510 in 3D space. For each pose of each video frame, block 310 determines a joint angle for each keypoint detected in the frame. A set of joint angles describes a pose of the body in each frame.

In some implementations, a set of the joint angles can be applied to portions (e.g., limbs, head, etc.) of a human body model to create a body pose. A sequence of body poses can be generated based on a set of joint angles being generated for each frame of the input video.

In some implementations, the sequence length of the output of the transformer can be reduced. For example, if the input dimensions are 21 times 30, the output sequence length is 630. The output can be reduced by aggregation to a smaller sequence length (e.g., 21 or 22) since a large part of the information in the sequence is not needed. For example, in some implementations, a fully-connected (FC) layer can be added to the output of the transformer 506 to perform a weighted summation among the original sequence length and reduce that length to a smaller sequence length. This allows detailed information about small body movements in the video to be captured, while still providing a smaller sequence length than the full sequence to enable reduced use of data storage.

An advantage of joint angle recovery block 310 is that it directly predicts and outputs joint angles of the keypoints, rather than predicting and outputting x, y, and z locations of the joint angles. Predicting x, y, and z 3D positions of joint angles may be more prone to errors, e.g., may have magnitude damping due to predicting neutral or unchanged poses when small changes in position have been made (e.g., such small position changes can be more difficult to determine when an object is distant from the camera).

FIG. 6 is a block diagram illustrating an example global translation recovery block 312. As shown in FIG. 6, global translation recovery block 312 receives, as input, the 2D keypoint sequence 502 derived from multiple frames as provided by the 2D keypoint detection block 308 of FIG. 3.

In some implementations, 2D keypoints sequence 502 is fed into a spatial-temporal transformer 602 of block 312 that can include a machine learning model, such as a deep neural network machine learning model. In some implementations, transformer 602 is a separate transformer from transformer 506 of FIG. 5. Transformer 602 finds correlations and relationships between the input 2D keypoint positions to determine a global translation of the keypoints.

Spatial-temporal transformer 602 receives the keypoint sequence 502 and determines a global translation. For example, the global translation can be indicated by translation parameters such as world coordinates that specify the location of a human body model in a space or environment, e.g., based on one or more reference points of the model (such as a particular keypoint) with reference to an origin in the environment. Current one-shot approaches may not accurately recover the global translation of human pose in this type of application, due to ambiguity of human size and the size of the person depicted in the video frames of the input video, the distances depicted in the video frames of the input video (e.g., distance from camera to subject), different intrinsic camera parameters, etc. Such characteristics can cause a deep neural network to have difficulties to determine the real location of the person in the depicted environment and thus difficulties to learn to predict global translation. Importantly, the input space of translation is large and the training data is more scarce when the location of the person is further away from an origin point, leading to severe motion dampening.

In order to reduce the input space, described techniques train the machine learning model of transformer 602 to fit translation velocity instead of location. This introduces input invariance with respect to location (deep neural network prediction is no longer dependent on location) and reduces the difficulty of the learning procedure for the machine learning model.

Thus, the spatial-temporal transformer 602 is trained to predict the velocity of global translation of the keypoints of a model (or the velocity of a particular keypoint of the model) between each frame. In some implementations, the velocity can be determined as the change in position (e.g., location delta) of one or more particular keypoints (e.g., each particular keypoint) of the body model between successive frames, and this velocity is used as training data for the transformer 602 such that the transformer 602 predicts the distance that the keypoint has moved between each frame. In some implementations, spatial-temporal transformer 602 can be implemented similarly as spatial-temporal transformer 506 described herein, e.g., can repeatedly encode the inputs in spatial dimensions (within frame) and temporal dimension (across frames) separately. For example, transformer 602 can be a 12-layer transformer and can be composed of six blocks, where each block includes two transformers: a temporal transformer that computes a temporal dimension, and then a spatial transformer that computes a spatial dimension, similarly as described above for transformer 506. Other amounts of layers and blocks can be used in other implementations. Transformer 602 can be implemented as other types of machine learning models in other implementations.

The output of the transformer 602 can be the translation velocity of each keypoint for each frame. For example, if there are 21 keypoints and 30 frames, the translation velocity of these keypoints in each frame are output. In some examples, the output can be in the form of (delta x, delta y, delta z) for each keypoint, indicating the change in distance of the keypoint in each of three dimensions, or other format can be used to indicate the velocity or change in distance between successive frames.

The translation velocity is input to integration block 604 and is integrated (mathematical integration operation, as indicated by the integral sign ∫ in FIG. 6) by integration block 604 to determine an (x,y,z) location (world coordinates) of each keypoint of each frame, e.g., with reference to an origin location. This location information is global translation output 606 in which global translation of the keypoints is recovered.

FIG. 7 is a block diagram illustrating an example smoothing filter 314. As shown in FIG. 7, filter 314 receives an n-dimensional sequence 702 which is a sequence of poses corresponding to the frames of the input video 302. Each pose in the sequence includes joint angles and translation coordinates from blocks 310 and 312 for each of the keypoints in each frame, as described above.

The predicted human pose joint angles and translation in sequence 702 may be subject to jitter. For example, some keypoints determined in the 2D keypoint detection block 308 may not be accurate in their detected or predicted positions, and this inaccuracy can propagate to the predicted joint angles and translation of poses in sequence 702. In some implementations, this jitter may mainly occur on a limited number of video frames over long sequences of video frames, e.g., as outliers of extreme motion or acceleration.

Smoothing filter 314 automatically detects such jitter in the video frames and adjusts the corresponding pose joint angles and translation. The filter can suppress cases and outliers of extreme acceleration of body parts of the poses in the entire sequence by a particular degree, thus smoothing the overall trajectory of the body parts and reducing the jitter.

Filter 314 includes an acceleration smoothing filter 706, which can be a sparse error sparse acceleration (SESA) filter. The received sequence of joint angles and translations is filtered channel-wise using filter 706. In some implementations, this filter solves an optimization problem which minimizes an L1 recovery error (using the L1 loss function) for an acceleration of one or more keypoints in the input pose sequence 702. In some implementations, the solution of the optimization problem can include using an alternating direction method of multipliers (ADMM) solver in filter 706. The ADMM is used for distributed convex optimization and solves convex optimization problems by separating variables into sub-problems that can be solved iteratively and faster. Such a solver is fast and can be used to filter real-time pose sequences for video, as in some implementations herein.

In some example implementations, an acceleration is determined among the joint angles. If there are large outliers in the keypoints, there will be large spikes of acceleration among the joint movements. The optimization punishes large, sudden accelerations in keypoint joint angles.

In some example implementations, the ADMM solver in filter 706 can use an L1 loss function the majority of iterations to quantify errors in prediction, e.g., differences between the solver's predictions and actual target joint angles and translations, where the target joint angles (ground truth) are the accelerations of joint angles and translations that are determined by using an optimization algorithm (examples described below, e.g., using matrix B). When the error is closer to zero (e.g., near the bottom of loss function e.g., within a threshold of the bottom), the ADMM solver can also use an L2 loss function to guide optimization, which enables the optimization to converge within fewer iterations than when using the L1 loss function alone (e.g., the L1 loss can be made to look like L2 loss for optimization). This fast convergence is suitable for real-time estimation of body poses from video data. For example, an L2 loss function is easier to minimize, being smooth and convex, unlike an L1 loss function. In some example implementations, the ADMM solver can converge on a solution within 100 iterations.

An example technique for optimizing the acceleration can include the following. Other techniques can also be used. Y∈R^{N×M} is the estimated orientation of joint angles in a 6D representation for a sequence of poses (e.g., the 6D joint angles can be directly fed into the smoothing filter). For example, if there are 30 frames of poses and 21 joint angles in each pose, N=30 and M=21×6 dimensions=126. Y is applied with a matrix B∈R^{N×N} to compute the acceleration, such that BY represents a sequence of angle accelerations. When there are jitters in the acceleration sequence, those jitters are to be suppressed since they are mostly errors from the estimation of keypoints. At the same time, the estimated sequence is to capture (and not suppress) large moving direction changes (such as persons waving hands). Since these large moving direction changes occur sparsely in the entire sequence, an L1 loss function is used to minimize the acceleration in the sequence, so that such large accelerations are allowed to appear occasionally, and for the majority of motions in the poses, acceleration is forced to be zero to suppress jitters.

In some implementations, the optimization problem can be defined as

$$X = arg {min}_{X} ‖ Y - BX ‖ + λ {‖ BX ‖}_{1} \qquad ( 1 )$$

where λ is a regularization parameter to control the strength of acceleration suppression.

Below is example pseudocode that illustrates an example algorithm for the ADMM solver to filter accelerations as described above using optimization problem (1), and having a maximum number of iterations of 200 in this example.

```
function ADMMProximal(Y, B, λ = 1, ρ = 1, max_iter = 200)
  N,M ← dimensions of Y
  _B ← B[: N − 3, : N]
  A ← λ · (_B^{T} · _B) + ρ · IN
  X ← zeros(N,M)
  U ← zeros(N,M)
  Z ← zeros(N,M)
  invA ← inverse(A)
  for i = 1 to max_iter do
    X ← ρ · (invA · (Z + Y − U))
    Z ← SoftThresholding(X − Y + U, 1/ρ)
    U ← U + (X − Z − Y)
  end for
  return X
end function
```

In the pseudocode above, Y is the ground truth of joint and translation location, B is a constant matrix that converts X into acceleration of joint angles/translation. U and Z are auxiliary variables in an augmented Lagrangian approach. The function zeros (N, M) creates an all-zero matrix with N rows and M columns. Lambda (λ) determines how smooth the filtered trajectory will be at the output. Rho (ρ) is a parameter to control the extent to which the optimization stays close to solving the optimization problem (1) over an L2 optimization. Max_iter is the maximum number of iterations of the optimization process.

Below is example pseudocode that illustrates an example of the soft thresholding function used in the pseudocode listed above.

```
function SoftThresholding(x, k)
  for all elements e in x do
    if |e| > k then
      e ← e − k
    else
      e ← 0
    end if
  end for
  return x
end function
```

In the above pseudocode, the absolute value of each element e (of total×elements) is compared to a threshold k. If it is larger than the threshold, the value of e is adjusted by subtracting the threshold k. Else, the value of e is set to zero. For example, e is a single element in the vector x and refers to the acceleration of the joints. By using soft thresholding on the acceleration value of a joint, a small value of acceleration is forced to be zero (most jitter corresponds to small values of acceleration), a smoothed trajectory results; since this only zeroes-out small values/accelerations, large accelerations (such as a sudden change of movement direction) are left untouched.

In some implementations, other solvers can be used instead of ADMM, such as deep learning based solvers (e.g., Adam, S3D, etc.). Other solvers may provide a slower convergence requiring a greater number of iterations to find a solution, and thus may require a longer time to process to provide filtered poses.

Filtered body pose sequences 708 are output from filter 706. In some implementations, the filtered sequences 708 can be parameters 316 that are the output of the 3D pose estimation system 306 of FIG. 3. The parameters 316 indicate body poses via joint angles and global translation for each body pose, where each body pose corresponds to a frame of the input video. In some implementations, pose sequences 708 can be used to animate an avatar as described above, e.g., in real-time response to input of input video 302 to system 306.

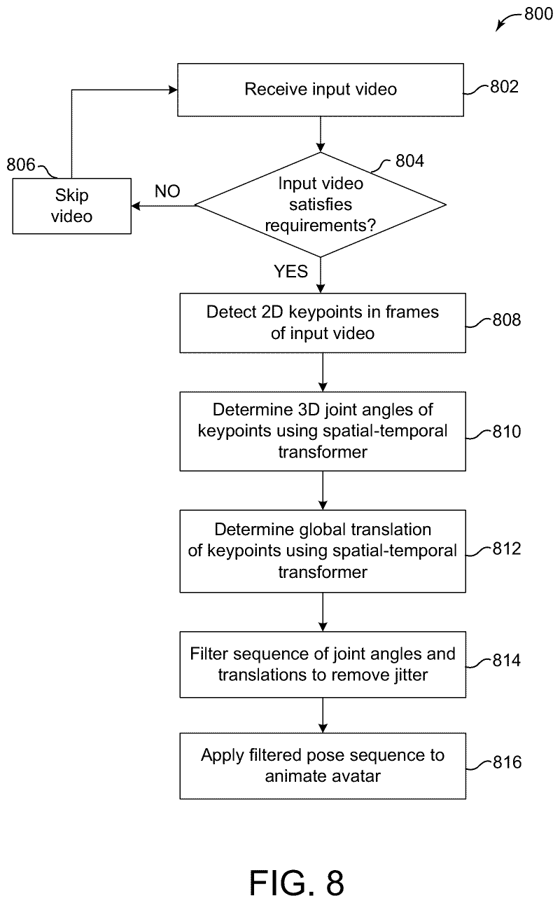

FIG. 8 is a flow diagram illustrating a method 800 to determine a pose sequence of 3D poses from an input video, in accordance with some implementations. In some implementations, method 800 can be implemented, for example, on a server system, e.g., online metaverse platform 102 as shown in FIG. 1. In some implementations, method 800 can be performed by an animation engine 107 of an online metaverse platform. In some implementations, some or all of the method 800 can be implemented on a system such as one or more client devices 110 and 116 as shown in FIG. 1, and/or on both a server system and one or more client systems. In described examples, the implementing system includes one or more processors or processing circuitry, and one or more storage devices such as a database, data structure, or other accessible storage. In some implementations, different components of one or more servers and/or clients can perform different blocks or other parts of the method 800. Method 800 may begin at block 802.

In block 802, an input video is received. The input video includes multiple frames, each frame being an image having image data defined by pixels. For example, with reference to FIGS. 2 and 3, the video can be an input video 202 or 302. Block 802 may be followed by block 804.

In block 804, it is determined whether the input video satisfies the requirements to be processed by method 800. For example, as described with reference to the pre-gating block 304 FIG. 3, the requirements can include that only a single person appears in the input video. In some implementations, more than one person is allowed to appear in the input video, and one of these persons is selected to be processed by method 800 (e.g., the person in the frames that has the largest bounding box). Other requirements can also be determined as described above, e.g., have a duration equal to or less than a particular duration.

If the requirements are not satisfied in block 804, the method continues to block 806 in which the input video is skipped and not processed by the remainder of method 800. Method 800 can return to block 802 to receive another input video.

If the requirements are satisfied in block 804, the method continues to block 808. In block 808, 2D keypoints are detected in the frames of the input video. For example, these keypoints can be detected as described above with reference to 2D keypoint detection block 308. Block 808 may be followed by block 810.

In block 810, 3D joint angles of the keypoints are determined using a spatial-temporal transformer. For example, the transformer 506 can be used as described above with reference to FIG. 5. In some implementations, the joint angles can be specified in six dimensions and converted to three dimensions as described above. Block 810 may be followed by block 812.

In block 812, global translation of keypoints is determined using a spatial-temporal transformer. For example, the transformer 602 can be used as described above with reference to FIG. 6. In some implementations, translation velocity is determined and integrated to provide translation spatial coordinates, as described above. Block 812 may be followed by block 814.

In block 814, the sequences of joint angles and translations from blocks 810 and 812 are filtered to remove jitter using a solver (e.g., an ADMM solver). For example, the filter can be smoothing filter 706 as described with reference to FIG. 7, which can suppress or reduce acceleration in movements of body parts in the pose sequence to reduce jitter caused by inaccurate keypoints. Block 814 may be followed by block 816.

In block 816, in some implementations, the filtered pose sequence from block 814 (including joint angles and translations) is used to animate an avatar. For example, the filtered pose sequence can include parameters 206 or 316 that describe 3D human poses, as described above. The animation of the avatar corresponds to the movement of the person depicted in the input video. For example, the positions of the joints and body parts of the avatar are adjusted based on the joint angles and translation parameters of corresponding keypoints in the pose sequence.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. For example, in some implementations, block 812 can be omitted, e.g., if global translation of body poses is not used, e.g., to animate an avatar (e.g., a person dances in place in the input video and the avatar is animated to dance in place). In some implementations, blocks and operations can be performed multiple times, in a different order, and/or at different times in the methods. For example, in some implementations, blocks 810 and 812 can be performed at least partially simultaneously.

The example methods and techniques can be implemented, for example, on a server system, e.g., online metaverse platform 102 as shown in FIG. 1. In some implementations, described techniques can be performed by an animation engine 107 of an online metaverse platform. In some implementations, some or all of the techniques can be implemented on a system such as one or more client devices 110 and 116 as shown in FIG. 1, and/or on both a server system and one or more client systems. In described examples, the implementing system includes one or more processors or processing circuitry, and one or more storage devices such as a database, data structure, or other accessible storage. In some implementations, different components of one or more servers and/or clients can perform different blocks or other parts of the described techniques.

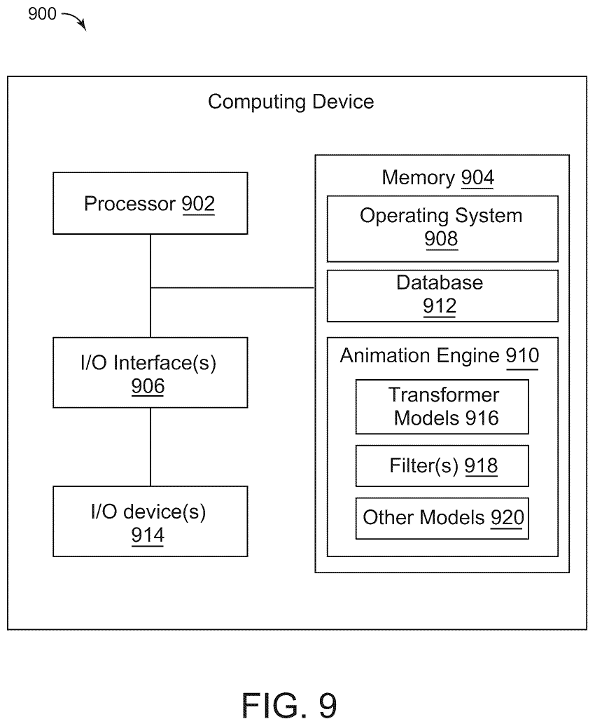

FIG. 9 is a block diagram of an example computing device 900 which may be used to implement one or more features described herein, in accordance with some implementations. In one example, device 900 may be used to implement a computer device (e.g., 102, 110, and/or 116 of FIG. 1), and perform appropriate method implementations described herein. Computing device 900 can be any suitable computer system, server, or other electronic or hardware device. For example, the computing device 900 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 900 includes a processor 902, a memory 904, input/output (I/O) interface 906, and audio/video input/output devices 914 (e.g., display screen, touchscreen, display goggles or glasses, audio speakers, microphone, etc.).

Processor 902 can be one or more processors and/or processing circuits to execute program code and control basic operations of the device 900. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 904 is typically provided in device 900 for access by the processor 902, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 902 and/or integrated therewith. Memory 904 can store software operating on the server device 900 by the processor 902, including an operating system 908, an animation engine 910, and associated data 912. In some implementations, animation engine 910 (and/or other engines) can include instructions that enable processor 902 to perform techniques and functions described herein, e.g., some or all of the implementations of FIGS. 2-8.

For example, memory 904 can include software instructions for animation engine 910 that can provide machine learning model training and/or pose sequence determination features as described herein, e.g., for an online metaverse platform 102 or other device or system. Any of software in memory 904 can alternatively be stored on any other suitable storage location or computer-readable medium. Various machine learning models and other models used in described features can be stored in memory 904 and/or other connected storage devices, including transformer models 916 (e.g., spatial-temporal transformers 506 and 602), filters 918 (e.g., filter 706), and other models 920 (e.g., model for 2D keypoint detection block 308). Further, memory 904 (and/or other connected storage device(s)) can store instructions and data used in the features described herein, e.g., video data, training data, pose sequences, global translation data, body model parameters, other parameters used by machine learning models, 3D meshes, etc. Memory 904 and any other type of storage (magnetic disk, optical disk, magnetic tape, or other tangible media) can be considered “storage” or “storage devices.”

I/O interface 906 can provide functions to enable interfacing the server device 900 with other systems and devices. For example, network communication devices, storage devices (e.g., memory and/or data store 108), and input/output devices can communicate via interface 906. In some implementations, the I/O interface can connect to interface devices including input devices (keyboard, gamepad or other game controller, pointing device, touchscreen, microphone, camera, scanner, etc.) and/or output devices (display device, speaker devices, printer, motor, etc.).

For ease of illustration, FIG. 9 shows one block for each of processor 902, memory 904, I/O interface 906, software blocks 908 and 910, and database 912. These blocks may represent one or more processors or processing circuitries, operating systems, memories, I/O interfaces, applications, and/or software modules. In other implementations, device 900 may not have all of the components shown and/or may have other elements including other types of elements instead of, or in addition to, those shown herein. While the online metaverse platform 102 may be described as performing operations as described in some implementations herein, any suitable component or combination of components of online metaverse platform 102 or similar system, or any suitable processor or processors associated with such a system, may perform the operations described.

A user device can also implement and/or be used with features described herein. Example user devices can be computer devices including some similar components as the device 900, e.g., processor(s) 902, memory 904, and I/O interface 906. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 914, for example, can be connected to (or included in) the device 900 to display images pre- and post-processing as described herein, where such display device can include any suitable display device, e.g., an LCD, LED, or plasma display screen, CRT, television, monitor, touchscreen, 3-D display screen, headset, projector, or other visual display device. Some implementations can provide an audio output device, e.g., voice output or synthesis that speaks text.

Various implementations as described herein are implemented with specific user permission for use of user data, e.g., videos, avatar data, etc. The user is provided with a user interface that includes information about how the user's information is collected, stored, and analyzed, and enables the user to control such use of the user's information. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

Various implementations described herein may include obtaining data from various sensors in a physical environment (e.g., video cameras), analyzing such data, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

The methods, techniques, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods or techniques.

In some implementations, some or all of the methods and techniques can be implemented on a system such as one or more client devices. In some implementations, one or more methods and techniques described herein can be implemented, for example, on a server system, and/or on both a server system and a client system. In some implementations, different components of one or more servers and/or clients can perform different blocks, operations, or other parts of the methods and techniques.

One or more of the methods and techniques described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more of the methods and techniques described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
obtaining an input video including a plurality of video frames in a sequence, wherein the video frames include pixels that depict movement of a person based on a plurality of poses of the person in the input video;
detecting, by at least one processor, keypoints of the person in the video frames of the input video; and
determining, by the at least one processor, a sequence of 3D body poses that correspond to the plurality of poses of the person in the video frames of the input video, wherein determining the 3D body poses includes using a spatial-temporal transformer to determine joint angles of the keypoints, wherein the spatial-temporal transformer separately encodes inputs in spatial dimensions within each video frame and in a temporal dimension across the video frames.

2. The computer-implemented method of claim 1, wherein the spatial-temporal transformer outputs 6-dimensional (6D) circular representations of the joint angles of the keypoints of the 3D body poses, wherein the method further comprises converting the 6D circular representations of the joint angles into 3-dimensional (3D) joint angles of the keypoints.

3. The computer-implemented method of claim 1, wherein determining the sequence of 3D body poses includes determining, by the at least one processor, a global translation in 3D world coordinates for the 3D body poses.

4. The computer-implemented method of claim 3, wherein determining the global translation in 3D world coordinates includes predicting translation velocity of the global translation.

5. The computer-implemented method of claim 3, wherein determining the global translation in 3D world coordinates includes using a second spatial-temporal transformer that separately encodes inputs in the spatial dimensions within each video frame and in the temporal dimension across the video frames.

6. The computer-implemented method of claim 1, further comprising smoothing, by the at least one processor, jitters in the sequence of 3D body poses using a smoothing filter that includes an optimization solver.

7. The computer-implemented method of claim 6, wherein the optimization solver includes an alternating direction method of multipliers (ADMM) solver.

8. The computer-implemented method of claim 6, wherein the smoothing filter minimizes an acceleration of one or more keypoints in the sequence of 3D body poses.

9. The computer-implemented method of claim 8, wherein the smoothing filter minimizes an L1 recovery error for the acceleration of the one or more keypoints in the sequence of 3D body poses.

10. The computer-implemented method of claim 1, further comprising applying the sequence of 3D body poses to an avatar in a virtual environment to cause an animation of the avatar based on the sequence of 3D body poses that corresponds to the movement of the person in the input video.

11. A system comprising:
at least one processor; and
a memory coupled to the at least one processor, with software instructions stored thereon that, when executed by the at least one processor, cause the at least one processor to perform operations comprising:
obtaining an input video including a plurality of video frames in a sequence, wherein the video frames include pixels that depict movement of a person based on a plurality of poses of the person in the input video;
detecting keypoints of the person in the video frames of the input video;
determining, using a transformer, 6-dimensional (6D) circular representations of joint angles of the keypoints, wherein the transformer outputs the 6D circular representations of the joint angles of the keypoints;
converting the 6D circular representations of the joint angles into 3-dimensional (3D) joint angles of the keypoints; and
outputting a sequence of 3D body poses that correspond to the plurality of poses of the person in the video frames of the input video, wherein the sequence of 3D body poses includes the 3D joint angles of the keypoints for the video frames of the input video.

12. The system of claim 11, wherein the transformer is a spatial-temporal transformer that separately encodes inputs in spatial dimensions within each video frame and in a temporal dimension across the video frames.

13. The system of claim 11, wherein the operations further include determining a global translation in 3D world coordinates for the 3D body poses using a transformer that predicts translation velocity of the global translation.

14. The system of claim 13, wherein the operation of determining the global translation in 3D world coordinates includes using a second spatial-temporal transformer that separately encodes inputs in spatial dimensions within each video frame and in a temporal dimension across the video frames.

15. The system of claim 11, wherein the operations further comprise smoothing jitters in the sequence of 3D body poses using a smoothing filter that includes an optimization solver.

16. The system of claim 15, wherein the smoothing filter minimizes an acceleration of one or more keypoints in the sequence of 3D body poses.

17. The system of claim 15, wherein the optimization solver includes an alternating direction method of multipliers (ADMM) solver.

18. The system of claim 11, wherein the operations further comprise applying the sequence of 3D body poses to an avatar in a virtual environment to cause an animation of the avatar based on the sequence of 3D body poses that corresponds to the movement of the person in the input video.

19. A non-transitory computer-readable medium with instructions stored thereon that, when executed by a processor, cause the processor to perform operations comprising:
obtaining an input video including a plurality of video frames in a sequence, wherein the video frames include pixels that depict movement of a person based on a plurality of poses of the person in the input video;
detecting keypoints of the person in the video frames of the input video; and
determining a plurality of joint angles for the detected keypoints that provide a sequence of 3D body poses corresponding to poses of the person in the video frames of the input video; and
determining a global translation in 3D world coordinates for the 3D body poses using a transformer that predicts translation velocity of the global translation.

20. The non-transitory computer-readable medium of claim 19, wherein the transformer is a spatial-temporal transformer that separately encodes inputs in spatial dimensions within each video frame and in a temporal dimension across the video frames.
